(19) United States
(12) Patent Application Publication
(10) Pub. No.: US 2005/0069660 A1
(43) Pub. Date: Mar. 31, 2005

(54) Composite film structure for manufacturing pouches using rotary thermic sealing

(76) Inventor: David C. Climenhage, Orono (CA)

Correspondence Address: POTTER ANDERSON & CORROON LLP;ATTN: KATHLEEN W. GEIGER, ESQ., P.O. BOX 951, WILMINGTON, DE, 19899-0951, US

(21) Appl. No.: 10/493,088

(22) PCT Filed: Oct. 21, 2002
(86) PCT No.: PCT/CA02/01591

Related U.S. Application Data
(60) Provisional application No. 60/345,436, filed on Oct. 19, 2001.

(51) Int. Cl. B32B 7/02; B32B 27/32; B27N 1/00

(52) U.S. Cl. 428/34.3; 428/36.91; 428/36.92; 428/218; 428/523

(57) ABSTRACT

A sealant layer for use in a composite film structure, which includes at least one non-melting layer, the structure being for manufacturing pouches for containing flowable material utilizing high speed vertical form, fill and seal processes with rotary thermic sealing, the sealant layer comprising from about 70 to about 90% by weight of a single-site catalyst C₄-C₁₀ ethylene alpha-olefin polymer having a density in the range of from 0.890 to about 0.912 gm/cc and a melt index in the range of from about 0.2 to about 2.0 dg/cc, and from about 10 to about 30% by weight of one or more of the following: a linear low density polyethylene selected from single-site catalyst and multi-site catalyst polymers, the polyethylenes having a density in the range of from about 0.916 to about 0.930 gm/cc, a high pressure low density polyethylene and processing additives.

### FIELD OF THE INVENTION

This invention relates to a composite film structure for use in the manufacture of small pouches by high speed vertical form, fill and seal machine that utilizes a rotary thermic sealing system. The pouches are of relatively small size ranging in volume of from about 5 mls and up. The pouches are meant to hold flowable materials such as condiments, dessert snacks, and other similar products.

### BACKGROUND OF THE INVENTION

There are a variety of vertical, form, fill and seal machines available which can be used to manufacture pouches for containing flowable materials of various sizes and shapes. The vertical form, fill machines produced by Prepac, are used extensively in the dairy industry in North America. Generally, the volume of these packages may range from about 200 mls to about two or more litres. The pouch manufactured by such machines is in tubular form and has transversely heat-sealed ends. Each pouch is made from a flat web of film by forming a tubular film therefrom with a longitudinal seal and subsequently flattening the tubular film at a first position and transversely heat-sealing said tubular film at the flattened position, filling the tubular film with a predetermined quantity of flowable material above the first position, flattening the tubular film above the predetermined quantity of flowable material at a second position and transversely heat sealing the tubular film at the second position. The seal that is formed is the result of sealing jaws which are provided with impulse sealing means. The sealing jaws come together and seal the film through the flowable material, simultaneously cutting the filled package off the tube, while the seal is made. Thus the jaws push the layers of film together and push the flowable material out of the way of the film to create the seal.

A wide variety of films have been found to be useful in the manufacture of pouches using the Prepac™ vertical form, fill and seal machines and the following patents describes resins and films that are typical of the types of film compositions that have been used successfully on such machines.

In DUPONT CANADA INC.'s PCT International Publication WO 95/10566 published Apr. 20, 1995, the disclosure of which is incorporated herein by reference, there are disclosed pouches for flowable materials wherein the sealant film is made from a SSC copolymer of ethylene and at least one C₄-C₁₀ alpha-olefin. Blends of these SSC copolymers with at least one polymer selected from multi site catalyst linear copolymers of ethylene and at least one C₄-C₁₀ alpha-olefin, a high pressure polyethylene and blends thereof.

In DUPONT CANADA INC.'s PCT International Publication WO 95/21743 published Aug. 17, 1995, the disclosure of which is incorporated herein by reference, there is disclosed an ethylene copolymer film of improved stiffness for use in the manufacture of fluid containing pouches. Typically, the structure comprises an interposed layer of polyethylene having a thickness in the range of 5 to 20 microns and a density of at least 0.93 gm/cc and a melt index of from about 1 to 10 dg/minute, and at least one outer layer being a SSC or metallocene polyethylene/alpha-olefin film which may have a density in the range of 0.88 to 0.93 gm/cc. The only requirements placed on the stiffening interposed layer are that it be of a particular thickness and density. These are greater in the stiffening layer than in the metallocene or SSC layer(s). This application indicates that the stiffening layer is included in order for the fluid containing pouch to stand up properly so that fluid may be poured from it when the pouch is placed in a supporting container.

DUPONT CANADA INC.'s U.S. Pat. No. 4,503,102(Mollison) and U.S. Pat. No. 4,521,437(Storms), the disclosures of which are incorporated by reference disclose a polyethylene film for use in the manufacture in a form, fill and seal process of a disposable pouch for liquids such as milk. U.S. Pat. No. 4,503,102 discloses pouches made from a blend of a linear copolymer of ethylene and a C₄ -C₁₀ alpha-olefin and an ethylene-vinyl acetate polymer copolymerized from ethylene and vinyl acetate. The linear polyethylene copolymer has a density of from 0.916 to 0.930 g/cm³ and a melt index of from 0.3 to 2.0 g/10 minutes. The ethylene-vinyl acetate polymer has a weight ratio of ethylene to vinyl acetate from 2.2:1 to 24:1 and a melt index of from 0.2 to 10 g/10 minutes. The blend disclosed in Mollison U.S. Pat. No. 4,503,102 has a weight ratio of linear low density polyethylene to ethylene-vinyl acetate polymer of from 1.2:1 to 24:1. U.S. Pat. No. 4,503,102 also discloses multi-layer films having as a sealant film the aforementioned blend.

U.S. Pat. No. 4,521,437 (Storms) describes pouches made from a sealant film which is from 50 to 100 parts of a linear copolymer of ethylene and octene-1 having a density of from 0.916 to 0.930 g/cm³ and a melt index of 0.3 to 2.0 g/10 minutes and from 0 to 50 parts by weight of at least one polymer selected from the group consisting of a linear copolymer of ethylene and a C₄-C₁₀-alpha-olefin having a density of from 0.916 to 0.930 g/cm³ and a melt index of from 0.3 to 2.0 g/10 minutes, a high-pressure polyethylene having a density of from 0.916 to 0.924 g/cm³ and a melt index of from 1 to 10 g/10 minutes and blends thereof. The sealant film disclosed in U.S. Pat. No. 4,521,437 is selected on the basis of providing (a) pouches with an M-test value substantially smaller, at the same film thickness, than that obtained for pouches made with film of a blend of 85 parts of a linear ethylene/butene-1 copolymer having a density of about 0.919 g/cm³ and a melt index of about 0.75 g/10 minutes and 15 parts of a high pressure polyethylene having a density of about 0.918 g/cm³ and a melt index of 8.5 g/10 minutes, or (b) an M(2)-test value of less than about 12%, for pouches having a volume of from greater than 1.3 to 5 litres, or (c) an M(1.3)-test value of less than about 5% for pouches having a volume of from 0.1 to 1.3 litres. The M, M(2) and M(1.3)-tests are defined pouch drop tests for U.S. Pat. No. 4,521,437. The pouches may also be made from composite films in which the sealant film forms at least the inner layer.

In Falla et al WO 93/02859 published Feb. 18, 1993, the disclosure of which is incorporated herein by reference, there is described the use of a linear ethylene copolymer in the manufacture of films used to make fluid containing pouches. These copolymers are characterised as ultra low density linear polyethylene (“ULDPE”) sold commercially as ATTANE™ by Dow and described as a linear copolymer of ethylene with at least one α-olefin having from 3 to 10 carbon atoms, for example, the ULDPE may be selected from ethylene-1-propylene, ethylene-1-butene, ethylene-1-pentene, ethylene-4-methyl-1-pentene, ethylene-1-hexene, ethylene-1-heptene, ethylene-1-octene and ethylene-1-decene copolymers, preferably ethylene-1-octene copolymer.

In Meka et al WO 93/03093 published Feb. 18, 1993, the disclosure of which is incorporated herein by reference, there are described metallocene polymers useful for making sealed articles, comprising ethylene interpolymers having a CDBI of at least 50% and a narrow molecular weight distribution or a polymer blend comprising a plurality of said ethylene interpolymers as blend components.

Films have been produced for such equipment using as a basis for such films, 35 the resins of Dow and Exxon which are generally characterized as metallocene or single site catalyst resins. The Exxon films have been described in U.S. Pat. No. 5,382,630 issued Jan. 17,1995 to Stehling et al and WO 93/03093 published Feb. 18, 1993 to Meka et al. Examples of resins produced by Dow Chemical Company are described in U.S. Pat. No. 5,508,051 issued Apr. 16, 1996 to Falla et al, U.S. Pat. No. 5,360,648 issued Nov. 1, 1994 to Falla et al, U.S. Pat. No. 5,278,272 issued Jan. 11, 1994 to Lai et al and U.S. Pat. No. 5,272,236 issued Dec. 21, 1993 to Lai et al. The disclosures of all of these patents are incorporated herein by reference.

There is another type of vertical form, fill and seal, pouch packaging machine called the Dangan™ machine manufactured by Nippon Seiki Co. Ltd. of Japan. This machine is designed to form, fill and seal small pouches containing flowable material and utilizing a rotary thermic sealing system, an example of which is described in European Patent 1 065 142 A1, published Jan. 3, 2001, the disclosures of which are incorporated herein by reference. The patent describes a filling and packaging machine adapted to vertically seal a film which is continuously fed to the machine by using a vertical sealing unit. The film is formed into a bottom sealed cylindrical body by laterally sealing the cylindrical film with a lateral sealing unit. Material is packed into the bottom of the cylindrical package, from a filling nozzle disposed in the film into the mouth of the package, the cylindrical body is fed further into the machine and the mouth or top of the package is laterally sealed and filling then continues above this seal. The film moves at constant speed. Thus the material is preferably packaged continuously, although intermittent packaging could be used. A material supply unit is joined to the filling nozzle and is adapted to supply the material.

The vertical, form, fill and seal machines typified by those sold by Prepac involve continuous flow of material to be packaged with intermittent feed of film through the machine. With the machines of the Dangan type, the film is fed through at a constant velocity which is substantially higher than the speed at which the Prepac machines run. This is because the rotary thermic sealing permits faster film passage and high speed sealing. With the machines of the Dangan type, the fill can be intermittent or continuous.

There is also disclosed in Japanese Laid Open Patent Application Publication No. 2000-255005, a laminated film for packaging comprising a base layer, a deposition layer formed on the front or back surface of the base layer, which deposition layer has superior gas barrier properties and moisture resistance. The deposition layer is covered with a coating layer and a heat fusion layer and then is laminated onto the rear surface of the base film layer. The base film layer may be biaxially oriented nylon, polyester or polypropylene films or monoaxially oriented Nylon 66 or cellophane film. The heat fusion layer may be primarily formed of polyethylene/vinyl acetate copolymer/polypropylene or the like. There is no mention of single site catalyst polymers in this structure. The deposition layer may be silicon oxide, aluminum oxide or aluminum of superior gas barrier properties. The crux of the invention appears to reside in the coating layer used to prevent delamination of the deposition layer and providing protection therefor. The coated layer is directed outwardly as opposed to inwardly. The coating layer is preferably formed by roll coating or melt extrusion coating a cellulose, polyamide, vinyl, polyester, polyolefin, polyurethane or acrylic resin material. This patent is concerned with improving the easy-tear opening of the pouch. It is not concerned with machine productivity or running speed.

We have now found that the conventional films used in vertical form, fill, seal liquid pouch packaging machines (e.g. Prepac machines) will not run effectively on machines such as the Dangan machine. When these conventional linear low density polyethylene sealant layers are used on a Dangan type machine, they do not work particularly well. Machine speed must be slowed down as there is a narrow temperature range or operating window for running the machine. It is apparent that all heat for sealing the films must transfer through the entire thickness of the film from the outer release film to the inner surface of the sealant film in order to achieve sufficient melting to obtain a suitable seal. With the films just described, the slower speed is required to provide adequate heat for the seal. In Prepac, the entire film structure, single layer or multiple layer is melted and sealed in one operation. The Dangan machine separates sealing and pouch cut-off into separate operations. The outer layer must not melt while heat is transferred to the inner layer for sealing. Thus there is a need for a film for the Dangan machine which is as effective at producing pouches, as the films, which have been found to be useful on the Prepac machine.

### SUMMARY OF THE INVENTION

Thus the present invention provides a sealant layer for use in a film structure which includes at least one non-melting outer layer for manufacturing pouches utilizing high speed vertical, form, fill and seal processes with rotary thermic sealing. The sealant layer comprises from about 70 to about 90% by weight of a single-site catalyst C₄-C₁₀ ethylene alpha-olefin polymer having a density in the range of about 0.890 to about 0.912 gm/cc and preferably from about 0.896 to about 0.902 gm/cc and a melt index in the range of from about 0.2 to about 2.0 dg/cc, preferably from about 0.5 to about 1.0 dg/cc, and from about 10 to about 30% by weight of one or more of the following: a linear low density polyethylene which may be a single-site or multi-site catalyst polymer, a high pressure low density polyethylene, the polyethylene(s) having a density in the range of from about 0.916 to about 0.930 gm/cc, and processing additives. Preferably a linear low density polyethylene is used and the amount ranges from about 15 to about 25% by weight.

The sealant layer may be a monolayer film or it may be the innermost layer of the composite film.

The structure may comprise a first layer adjacent the non-melting layer, which first layer comprises from about 50 to about 100% by weight, preferably from about 50 to about 80% by weight, of linear low density polyethylene which may be a single-site or multi-site catalyst polymer having a density in the range of from about 0.916 to about 0.930 gm/cc, and from about 20 to about 50% by weight, preferably from about 20 to about 50% by weight, of a single-site catalyst C₄-C₁₀ ethylene alpha-olefin polymer having a density in the range of about 0.890 to about 0.912 gm/cc, preferably from about 0.896 to about 0.902 gm/cc and a melt index in the range of from about 0.2 to about 2.0, preferably from about 0.5 to about 1.0 dg/cc, a second layer of linear low density polyethylene having a density in the range of from about 0.916 to about 0.930 gm/cc, and a sealant layer of about 80% by weight of single-site C₄-C₁₀ ethylene alpha-olefin polymer having a density in the range of about 0.890 to about 0.912 gm/cc, preferably from about 0.896 to about 0.902 gm/cc and a melt index in the range of from about 0.2 to about 2.0 dg/cc, and about 20% by weight of linear low density polyethylene having a density in the range of from about 0.916 to about 0.930 gm/cc. In the case where the linear low density polyethylene in the first layer comprises up to 80% by weight, the remainder may be high pressure low density polyethylene.

Preferably, the sealant layer is from about 30 to about 70 microns thick and the non-melting layer is from about 12 to about 15 microns thick. More preferably, the sealant layer is from about 40 to 52 microns thick.

Preferably, the layer or layers adjacent the non-melting layer are from about 40 to about 52 microns thick and the sealant layer is from about 10 to about 20 microns thick.

In the composite film structure of the invention which incorporates a sealant layer as described above, the non-melting layer is selected from biaxially oriented polyethylene terephthalate (PET), biaxially oriented Nylon 6, monoaxially oriented Nylon 66, and biaxially oriented polypropylene.

The non-melting layer may be coated with any suitable barrier material known in the film and packaging arts. More particularly, the barrier coating may be selected from PVDC, SiOx, aluminium and aluminium oxides. When a coated non-melting layer is used in the film structure, the coated surface is directed inwardly and thereby protected by the sealant layer to which it is adhered in the structure.

The layers of the composite film structure are laminated together, preferably adhesively. The sealant layer may be produced by extrusion or co-extrusion.

In another form of the invention, the composite film structure may also include a layer of linear low density polyethylene and EVOH surrounded on either side with an adhesive layer, interposed between the sealant layer and the non-melting layer.

In a preferred embodiment, the invention provides a composite film structure comprising a non-melting layer selected from biaxially oriented polyethylene terephthalate (PET) coated with PVDC or SiOx. The non-melting layer may be selected from the group of films comprising biaxially oriented polyethyleneterephthalate (biaxially oriented polyester) and biaxially oriented Nylon 6, monoaxially oriented Nylon 66 and biaxially oriented polypropylene. All of these films have high enough melting points to prevent sticking to the sealing jaws and they provide for easy transverse tear for opening the package by tearing across the pouch from an edge slit.

The release film is laminated to a sealant film to form a multilayer film comprising a first layer composed of 40% by weight of a single-site catalyst C₄-C₁₀ ethylene alpha-olefin polymer having a density and melt index as in the first layer, 47% by weight of the mixed single-sitelmulti-site catalyst linear low density polyethylene having a density and melt index as in the first layer, 10% by weight of high pressure low density polyethylene and 3% by weight of slip, antiblock and extrusion aids and additives; a second layer of 100% by weight of the mixed single-site/multi-site catalyst linear low density polyethylene having a density and melt index as in the first layer, and a third or inner sealant layer which is composed of 78% by weight of a single-site catalyst C₄-C₁₀ ethylene alpha-olefin polymer having a density of 0.896 gm/cc and a melt index of 1.0 dg/cc, 18% by weight of a mixed single-site/multi-site catalyst linear low density polyethylene having a density of 0.920 gm/cc and a melt index of 0.50 dg/cc and 2% by weight of slip and antiblock additives.

More particularly, the present invention provides a composite film as described above for use in a pouch manufacturing process comprising a vertical form, fill and seal process that utilizes rotary thermic sealing, the pouches ranging in size from about 5 mls and up.

It has been found that the film structure of the invention operates at higher packaging speeds on the Dangan rotary thermic seal machine than conventional LLDPE (the preferred film used on the Prepac VFFS).

The film structure as defined above can be varied to provide oxygen and moisture barrier to extend product protection and shelf life. Methods for doing this include polyvinylidenechloride coating on the outer release film layer; metalization of the release film; SiOₓ or alumina or aluminum vacuum coating; or aluminum foil by lamination. These coatings are normally locked into the structure by being next to the sealant layer. The presence of EVOH in the film can be achieved by coextrusion or lamination and it of course offers barrier properties as the other alternatives previously mentioned provide. Thus the EVOH layer may be replaced by these other components, if desired.

In the accompanying drawings which are used to illustrate the present invention,

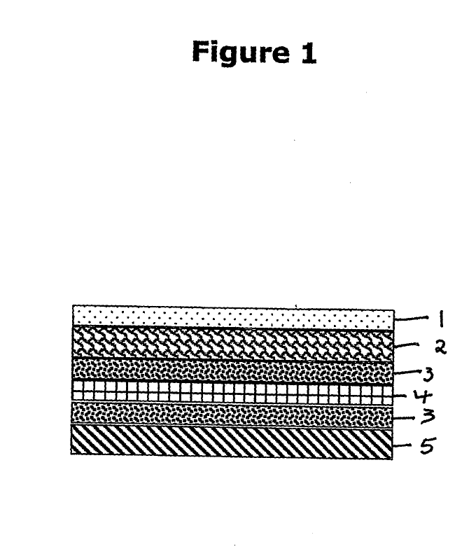

FIG. 1 is a schematic representation of an embodiment of a 6-layer film structure of the present invention;

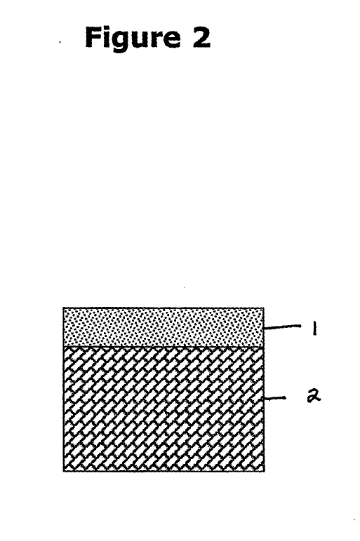

FIG. 2 is a schematic representation of an embodiment of a 2-layer film structure of the present invention;

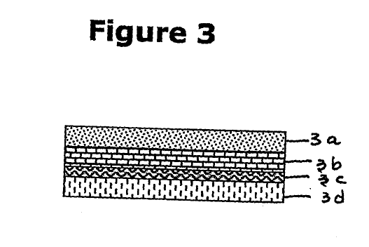

FIG. 3 is a schematic representation of an embodiment of a multilayer film structure of the present invention; and

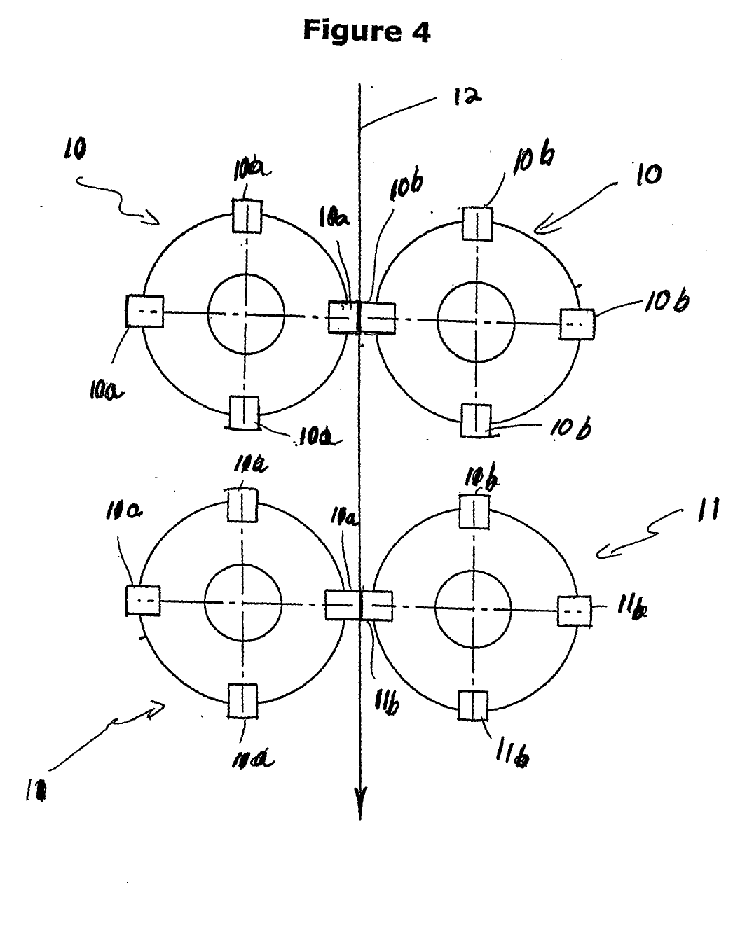

FIG. 4 is a schematic representation of a vertical form and fill machine which employs a rotary thermic sealing system which may be used to make pouches in accordance with the present invention.

### DETAILED DESCRIPTION OF THE INVENTION

The film structure shown schematically in FIG. 1 comprises a six layer film wherein layer 1 is the non-melting layer and comprises oriented polyester, nylon or polypropylene, layer 2 is a linear low density polyethylene, layer 3 is an adhesive layer which may be selected from suitable commercially available adhesives, an example of which is Bynel® available from E.I. du Pont de Nemours and Company. Another is a polyurethane adhesive available under the trade-mark Liofol. Layer 4 is EVOH, ranging in thickness of from about 4 to about 12 microns. Layer 5 is the sealant layer and preferably comprises from about 70 to about 90% by weight of a single-site catalyst C₃-C₂₀ ethylene alpha-olefin having a density in the range of about 0.810 to about 0.912 gm/cc, preferably about 0.896 to about 0.902 gm/cc, and a melt index in the range of about 0.2 to about 2.0 dg/cc, preferably from about 0.5 to about 1.0 dg/cc, and from 10 to about 30% by weight of one or more of the following: a linear low density polyethylene, a high pressure low density polyethylene, the polyethylene(s) having a density of from about 0.916 to about 0.930 gm/cc and processing additives.

The sealant film may be manufactured using any conventional film manufacturing process. The non-melting layer is always placed in the structure so that it is the layer in contact with the sealing jaws or device of the vertical form, fill and seal machine. This ensures that the film is easily released from the jaws during packaging.

In FIG. 2, there is shown another example of a film structure for use in making pouches on a vertical form, fill pouch making machine. In this structure, layer 1 is a non-melting layer consisting of oriented polyester, nylon or polypropylene film upon which a polyvinylidene coating (PVDC) has been deposited in accordance with techniques known in the art. Layer 2 is a sealant layer of the same composition as the sealant layer present in the embodiment of FIG. 1. Alternatively, the PVDC may be applied to the sealant layer.

In FIG. 3, there is shown an example of a film that comprises a top, non-melting layer 3a and a sealant film which comprises three layers, a layer 3b comprising a linear low density polyethylene layer with a single-site catalyst C₄-C₁₀ ethylene alpha-olefin polymer, a layer 3c comprising a linear low density polyethylene and a layer 3d comprising 80% by weight of a single-site catalyst C₄-C₁₀ ethylene alpha-olefin polymer with 20% by weight of a linear low density polyethylene. The densities and melt indices for these polymers are as defined for the emboeiment of FIG. 1.

These multilayer sealant films are made on blown or cast co-extrusion film manufacturing lines capable of making films of 3 to 5 layers. The sealant layer can be laminated to the non-melting layer by adhesive (usually urethane). Many adhesives are known for this purpose.

Referring now to FIG. 4 of the accompanying drawings, there is shown schematically a horizontal sealing component of a rotary thermic sealing machine.

Shown generally at 10 are heated jaws 10a and 10b (four per side) through which a film can be fed through film path 12.

Shown generally at 11 are cooling jaws 11a and 11b through which the film is fed after passing through heated jaws 10a and 10b.

After passing through heated jaws 10a and 10b and then cooling jaws 11a and 11b, the cooled packages may be fed to a cutter (not shown) where the packages may be cut.

The packages may be formed into single or double lanes of individual pouches as can be seen in FIG. 4. The packages may be formed by sealing any of 2, 3 or 4 sides, with 3 being preferred.

The film speed through the machine is at constant speed and can range from about 10 to about 30 meters per minute.

The surfaces of the side or vertical sealing jaws are preferably knurled to facilitate feeding of the film through the machine. This creates a knurled pattern in the seal.

The packaging operation for which the film and process are frequently used is one which involves hot fill conditions which sterilize the product and the package.

Most products packaged on the unit are filled at a temperature of 95° C. This sterilizes the product and package to make them shelf stable when stored at room temperature. At a hot fill temperature of 85 to 95° C., the burst pressure of the pouch is reduced dramatically because the package temperature immediately after filling is close to the melting point of the sealant Blends with metallocene LLDPE (hybrid copolymer) were evaluated to find a blend range where optimum performance could be achieved. These hybrid copolymer films are described in PCT Application No. PCT/CA98/00799, the disclosures of which are enclosed herewith in duplicate. Relatively low levels of the metallocene LLDPE were found to improve the high temperature burst strength without requiring a lowering of machine speed. It appears that a surprisingly low level is required and also a narrow range to get good high temperature burst strength and good seal performance at high machine speed. At 25% by weight or higher, metallocene LLDPE blends with the ultra low density metallocenes, the machine speed is dramatically reduced. With levels of only 10 to 20% by weight of the metallocene LLDPE, a good balance of high machine speed and burst resistance at 95° C. was observed. These results seem unusual in that the low level of metallocene LLDPE of 0.920 density that it takes to stabilize burst pressure at 95° C. fill temperature and that this narrow range of blend is needed to avoid loss of sealability at high speed. Conventional LDPE or EVA blends at these lower levels are also considered to be suitable choices in the same blend ranges.

The cooling accomplished by the second set of transverse sealing jaws found in the Dangan machine must also transfer heat through the entire film thickness in reverse from inside to outside. It would appear that this process would favour the lowest possible melting point sealant films and hence the new films described herein have been developed to meet the criteria.

The preferred single-site catalyst ethylene alpha-olefin interpolymers in the lowest density range were evaluated as these provide the lowest possible melting point sealants. The commercial films evaluated included Dow PL1880 having 0.902 gm/cc density and Dow PF1146 having 0.896 gm/cc density. The resulting films were found to run much better than combinations of linear low density polyethylene and low density polyethylene blends which have been used on these machines. The film which appeared to be best was that prepared using the Dow PF1146 having a density of 0.896 gm/cc.

Problems are often encountered with films during hot fill conditions. Many products packaged on the Dangan filler are filled at a temperature of 90 to 95° C. This sterilizes the product and the package to make them shelf stable when stored at room temperature. At these hot fill temperatures, the burst pressure of the pouch is reduced dramatically because the temperature immediately after filling is close to the melting point of the sealant layer. Blends with metallocene linear low density polyethylene were evaluated to find a blend range where optimum performance could be achieved. Surprisingly, relatively low levels of metallocene linear low density polyethylene Improve high temperature burst strength without requiring a lowering of machine speed. It appears that a surprisingly low level of metallocene linear low density polyethylene is preferred and also having a narrow range to get good high temperature burst strength and good seal performance at high machine speed. At levels of 25% by weight or higher of metallocene linear low density polyethylene in blends with ultra low density metallocenes, the machine speed can be dramatically reduced. With levels of only 10 to 20% by weight, and 10 to 25% preferred, of the metallocene linear low density polyethylene a good balance of high machine speed and burst resistance at 95° C. is achieved. These results were perceived to be unusual with respect to the low level of metallocene linear low density polyethylene of 0.920 gm/cc density that it takes to stabilize burst pressure at preferred 95° C. fill temperature. It has been observed that this narrow range of blend is preferred, to avoid loss of sealability at high speed.

Even when hot fill is not used, the films of this invention offer high speed and stable sealing, heating and cooling.

The following examples are used to illustrate the present invention and should not be used to limit the scope of the claims.

### EXAMPLES

### Example 1

Film Structure 1A

Top Web: 12 micron Biaxially Oriented PET with PVDC Coating

(M34 Mylar®) Laminated with Liofol Polyurethane adhesive to the sealant film

Sealant Film formed from 3 layers 42 microns thick in total. E1332PA

Sealant inner sealing layer: 20 microns of 78% Dow Affinity® PF1146(0.896 Density, 1.0 M.I.) Contains slip and antiblock additives. 18% Dow Elite® 59900.57(0.920 Density, 0.50 M.I.) 2% additives slip & antiblock.

Sealant mid layer 3 microns of 100% Dow Elite® 59900.57

Sealant upper layer next to the PET 19 microns of 40% Dow Affinity® PF1146, 47% Dow Elite® 59900.57, 10% HP LDPE & 3% additives( slip, antiblock and extrusion aid)

Film Structure 1B

Top Web: 12 micron PET with SiOx coating

Sealant Film: 3 layer 51 micron thick: E1332

Sealant inner sealing layer 24 microns of 78% Dow Affinity® PF1146(0.896 Density, 1.0 M.I.) Contains slip and antiblock additives. 18% Dow Elite 59900.57(0.920 Density, 0.50 M.I.) 2% additives (slip & antiblock).

Sealant mid layer 3 microns of 100% Dow Elite® 59900.57

Sealant upper layer next to the PET 24 microns of 40% Dow Affinity® PF1146, 47% Dow Elite® 59900.57, 10% HP LDPE & 3% additives (slip, antiblock and extrusion aid)

Note Dow Elite® 59900.57 is a special grade of Hybrid LLDPE produced with dual catalyst system using single-site catalyst in a first reactor and multi-site catalyst in a second reactor.

Dangan™ Packaging Run

Sealed leak free packages were formed at the following machine settings on a Dangan® high speed Vertical Form, Fill, Seal Rotary Thermic Seal Packaging Machine.

63 Micron Film Structure 1B

| | |
|---|---|
| Film Speed | 15 meters/minute |
| Seal Pitch | 115 mm |
| Side Seal Temperature | 180° C. |
| End Seal Temperature | 165° C. |
| Side Seal Pressure | 100 Kilopascals |
| End Seal Pressure | 350 Kilopascals |

54 Micron Film Structure 1A

| | |
|---|---|
| Film Speed | 20 meters/minute |
| Seal Pitch | 115 mm |
| Side Seal Temperature | 185° C. |
| End Seal Temperature | 180° C. |
| Side Seal Pressure | 80 Kilopascals |
| End Seal Pressure | 300 Kilopascals |

### Example 2

The following three films were prepared.

Film 2A 63 Micron Film Structure

Top Web: 2 micron PET laminated with Liofol™ adhesive (polyurethane) to:

Sealant Film: 3 layer 51 micron thick: E1332

Sealant inner sealing layer: 24 microns of 78% Dow Affinity™ PF1146 (0.896 Density, 1.0 M.I.) Contains slip and antiblock additives. 18% Dow Elite™ 59900.57(0.920 Density, 0.50 M.I.) 2% additives slip & antiblock.

Sealant mid layer 3 microns of 100% Dow Elite 59900.57

Sealant upper layer next to the PET is 0.24 microns of 40% Dow Afflnity™ PF1146, 47% Dow Elite™ 59900.57, 10% HP LDPE & 3% additives (slip, antiblock and extrusion aids)

Film 2B 63 Micron Film Structure

Top Web: 12 micron PET laminated with Liofol™ to:

Sealant Film is a single layer of 51 micron Sclairfilm™ LX3. Composition is: 85%

Sclair™ 11L4 Octene Linear Low density Polyethylene with 0.6 Melt Index & 0.920 Density containing standard levels of additives including: slip, antioxidant, and antiblock. It also contains 15% high pressure Low Density Polyethylene.

Film 2C 63 Micron Film Structure

Top Web: 12 micron Biaxed PET with PVDC Coating ( M34 Mylar™) Laminated with Liofol™ Polyurethane adhesive to:

Sealant Film: 3 layer 51 microns E1332PA

Sealant inner sealing layer: 24 microns of 78% Dow Affinity™ PF1146(0.896 Density, 1.0 M.I.) Contains slip and antiblock additives. 18% Dow Elite™ 59900.57(0.920 Density, 0.50 M.I.)+2% additives slip & antiblock.

Sealant mid-layer 3 microns of 100% Dow Elite™ 59900.57

Sealant upper layer next to the PET is 24 microns of 40% Dow Affinity™ PF1146, 47% Dow Elite™ 59900.57,

10% HP LDPE & 3% additives (slip, antiblock & extrusion aids)

Dangan Packaging Run

Sealed, leak-free packages were formed at the following machine settings on a Dangan Vertical Form, Fill, Seal Rotary Thermic Seal Packaging Machine using the three films described above. The films 2A and 2C provided a machine productivity advantage of over 40% as compared with Film 2B, the octene linear low density polyethylene film.

The High Speed sealant Film 2A was set up first at run conditions that allowed leak free packages to be produced at fastest sustainable commercial operating packaging speed of 20 metres per minute and 181 packages per minute. One requirement is that pouches taken off the line must pass a 100 Kg compression test for 3 minutes without failure. It was also determined that this film laminate would not run leak free at higher speed without taking seal temperatures and pressures to extremes that were deemed unstable in continuous operation. In summary this was the fastest practical run speed for this particular film. 1000 packages were saved for further examination.

The standard Octene LLDPE sealent Film 2B was put on the Dangan machine second and an attempt was made to run it at the Identical conditions established for Film 2A. The packages did not seal and water leaked from each package. All seal temperatures and pressures were kept constant while run speed was reduced in steps until leak free packages were produced that could pass the 100 Kg pressure test for 3 minutes. It was determined that the standard sealant film could only run at 14 metres per minute and packaging speed was reduce from 181/minute with the experimental sealant Film 2A to 127/minute for the standard Octene blend sealant. This confirmed that the experimental high speed sealant had a 42.5% productivity advantage over the standard liquid packaging sealant. The additional 54 packages per minute possible with the improved sealant adds greatly to the commercial viability and productivity of the Dangan packaging machine.

Sealant Film 2C laminate has the identical sealant and PET Films to Film 2A but has an added PVDC barrier coating on the PET. The maximum run speed for this film was determined to be 16 meters per minute and 145 packages per minute. It appears that the additional PVDC coating in the structure cuts down heat transfer and causes some loss of production through-put at the established seal temperature and pressures but it also ran at higher speed than the laminate with Octene LLDPE sealant in Film 2B.

Run Settings

Film 2A (High Speed Sealant Laminated to uncoated Biaxed PET)

| | |
|---|---|
| Film Speed | 20 meters/Minute |
| Seal Pitch | 110 mm |
| Production Speed | 181 Packages/minute |
| Side Seal Temperature | 220 Degrees Centigrade |
| End Seal Temperature | 185 Degrees Centigrade |
| Side Seal Pressure | 120 Kilopascals |
| End Seal Pressure | 500 Kilopascals (left & right) |
| Tension | 500 g |

Product at Room Temperature conditioned in a tank for 3 days

Pouch Pressure test Passed at 100 Kg for 3 Minutes

Film 2B (Standard Octene LLDPE Sealant
Laminated to Uncoated PET)

| | |
|---|---|
| Film Speed | 14 meters/minute |
| Seal Pitch | 110 mm |
| Production Speed | 127 Packages/minute |
| Side Seal Temperature | 220 Degrees C. |
| End Seal Temperature | 185 Degrees C. |
| Side Seal Pressure | 120 Kilopascals |
| End Seal Pressure | 500 Kilopascals (left & right) |
| Tension | 500 g |

Product at Room Temperature conditioned in a tank for 3 days

Pouch Pressure test Passed at 100 Kg for 3 Minutes

Film 2C (High Speed Sealant Laminated to PVDC Coated PET)

| | |
|---|---|
| Film Speed | 16 meters/minute |
| Seal Pitch | 110 mm |
| Production Speed | 145 Packages/minute |
| Side Seal Temperature | 220 Degrees C. |
| End Seal Temperature | 185 Degrees C. |
| Side Seal Pressure | 120 Kilopascals |
| End Seal Pressure | 500 Kilopascals (left & right) |
| Tension | 500 g |

Product at Room Temperature conditioned in a tank for 3 days

Pouch Pressure test Passed at 100 Kg for 3 Minutes

The invention may be varied in any number of ways as would be apparent to a person skilled in the art and all obvious equivalents and the like are meant to fall within the scope of this description and claims. The description is meant to serve as a guide to interpret the claims and not to limit them unnecessarily.

1. A sealant layer for use in a composite film structure, which includes at least one non-melting layer, the structure being for manufacturing pouches for containing flowable material utilizing high speed vertical form, fill and seal processes with rotary thermic sealing, the sealant layer comprising from about 70 to about 90% by weight of a single-site catalyst C₄-C₁₀ ethylene alpha-olefin polymer having a density in the range of from 0.890 to about 0.912 gm/cc and a melt index in the range of from about 0.2 to about 2.0 dg/cc, and from about 10 to about 30% by weight of one or more of the following: a linear low density polyethylene selected from single-site catalyst and multi-site catalyst polymers, the polyethylenes having a density in the range of from about 0.916 to about 0.930 gm/cc, a high pressure low density polyethylene and processing additives.

2. A sealant layer as claimed in claim 1, wherein the single-site catalyst C₄-C₁₀ ethylene alpha-olefin polymer has a density of from 0.896 to about 0.902 gm/cc.

3. A sealant layer as claimed in claim 1, which comprises a monolayer film.

4. A sealant layer as claimed in claim 1 which comprises a multilayer film.

5. A sealant layer as claimed in claim 4, wherein the multilayer sealant film comprises a first layer for use adjacent the non-melting layer which first layer comprises from about 50 to about 100% by weight of linear low density polyethylene and from 0 to about 50% by weight of a single-site or multi-site catalyst C₄-C₁₀ ethylene alpha-olefin polymer having a density in the range of from 0.916 to about 0.930 gm/cc and a melt index in the range of from about 0.2 to about 2.0 dg/cc, and a second layer of linear low density polyethylene and a sealant layer of about 80% single site catalyst C₄-C₁₀ ethylene alpha-olefin polymer having a density in the range of from 0.896 to about 0.912 gm/cc and a melt index in the range of from about 0.2 to about 2.0 dg/cc, and about 20% linear low density polyethylene.

6. A sealant layer as claimed in claim 5, wherein the first layer comprises up to 20% by weight of high pressure low density polyethylene.

7. A sealant layer as claimed in claim 3, wherein the sealant layer is from about 30 to about 70 microns thick and the non-melting layer is from about 12 to about 15 microns thick.

8. A sealant layer as claimed in claim 7, wherein the sealant layer is from about 40 to 52 microns thick.

9. A sealant layer as claimed in claim 5, wherein the layers adjacent the non-melting layer are from about 40 to about 52 microns thick and the third layer is from about 10 to about 20 microns thick.

10. A composite film structure which incorporates a sealant layer as claimed in claim 1 and the non-melting layer is selected from biaxially oriented polyethylene terephthalate, biaxially oriented Nylon 6, monoaxially oriented Nylon 66 and biaxially oriented polypropylene.

11. A composite film structure which incorporates a sealant layer as claimed in claim 5 and the non-melting layer is selected from biaxially oriented polyethylene terephthalate, biaxially oriented Nylon 6, monoaxially oriented Nylon 66 and biaxially oriented polypropylene.

12. A composite film structure as claimed in claim 11 in which the non-melting layer has a barrier coating.

13. A composite film as claimed in claim 12, wherein the barrier coating is selected from PVDC, SiOx, aluminium and aluminium oxides.

14. A composite film structure as claimed in claim 10 or 11, wherein there are also present a layer of linear low density polyethylene and a layer of EVOH surrounded on either side with an adhesive layer.

15. A composite film structure comprising a non-melting layer selected from biaxially oriented polyethylene terephthalate (PET) coated with PVDC or SiOₓ and a sealant film which is a multilayer film comprising a first layer composed of 40% by weight of a single-site catalyst C₄-C₁₀ ethylene alpha-olefin polymer having a density of 0.896 gm/cc and a melt index of 1.0 dg/cc, 47% by weight of the mixed single-site/multi-site catalyst linear low density polyethylene having a density of 0.920 gm/cc and a melt index of 0.50 dg/cc, 10% by weight of high pressure low density polyethylene and 3% by weight of slip, antiblock and extrusion aids and additives; a second layer of 100% by weight of the mixed single-sitelmulti-site catalyst linear low density polyethylene having a density of 0.920 gm/cc and a melt index of 0.50 dg/cc; and a third or inner sealant layer which is composed of 78% by weight of a single-site catalyst C₄-C₁₀ ethylene alpha-olefin polymer having a density of 0.896 gm/cc and a melt index of 1.0 dg/cc, 18% by weight of a mixed single-site/multi-site catalyst linear low density polyethylene having a density of 0.920 gm/cc and a melt index of 0.50 dg/cc and 2% by weight of slip and antiblock additives.
